(19) United States
(12) Patent Application Publication
(10) Pub. No.: US 2010/0163592 A1
(43) Pub. Date: Jul. 1, 2010

(54) PROCESS AND APPARATUS FOR SCORING AND BREAKING INGOTS

(75) Inventors: Bruce DeClark, Grand Rapids, MI (US); Melvin Hawke, Radford, VA (US)

Correspondence Address: MCGARRY BAIR PC, 32 Market Ave. SW, SUITE 500, GRAND RAPIDS, MI, 49503, US

(73) Assignee: SUPERIOR PRESS & AUTOMATION, INC., Grand Rapids, MI (US)

(21) Appl. No.: 12/280,028

(22) PCT Filed: Feb. 20, 2007
(86) PCT No.: PCT/US2007/062415

§ 371 Date: Aug. 20, 2008

Related U.S. Application Data
(60) Provisional application No. 60/743,322, filed on Feb. 20, 2006.

(51) Int. Cl. B26F 3/00

(52) U.S. Cl. 225/2; 225/96

(57) ABSTRACT

An apparatus for scoring and breaking ingots (100) into charges (150) comprises a scoring station (12) and a breaking station (14). The scoring station (12) includes a lathe that makes a shallow, circumferential groove (102, 104) in the ingot at a desired charge length. The breaking station (16) includes a hydraulic press (64) that impacts a charge portion (110) of the ingot to break a charge (150) from the ingot at a scoring line (106). The apparatus can further include a control system to automate the process and to weigh an ingot at different points along the length of the ingot, calculating the density of the ingot, and using the information to determine a desired charge length needed for a given weight of material.

### CROSS-REFERENCE TO RELATED APPLICATION

This application claims the benefit of U.S. provisional application Ser. No. 60/743,322, filed Feb. 20, 2006, which is incorporated herein in its entirety.

### BACKGROUND OF THE INVENTION

1. Field of the Invention

The invention relates generally to a process for breaking ingots into individual charges for later processing. In another aspect, the invention relates to an apparatus for breaking an ingot into separate charges by scoring the ingot and breaking it with a press.

2. Description of the Related Art

Metals, including superalloys of titanium, nickel, and cobalt are commonly formed as ingots for storage or shipping and are later used to form a desired part, usually by melting and casting the ingot or a portion of the ingot. Ingots can be formed using a vacuum melt or air melt process which involves pouring a molten mass of material into an upstanding cylindrical mold where the material is allowed to cool. As the material cools in the mold, a density gradient forms due to gravity, where the ingot is denser near the bottom of the mold and less dense near the top. Further, a depression commonly referred to as a “pipe” forms at the top of the mold due to the uneven cooling of the material within the mold. Thus, ingots are often not homogeneous in composition or structure and, as well, multiple ingots are not homologous with respect to each other.

Superalloys are typically used in the formation of precision parts in the aerospace and medical industries, e.g., turbine blades and surgical implants. Typical exemplary superalloys carry trademarks such as Inconel®, Mar®, and Rene®. Ingots normally come from the mill in diameters ranging from 2″ to 20″ and in lengths up to four feet or more. When a particular amount of material is needed for a desired part, a portion of the ingot, commonly referred to as a charge, is separated from the ingot for further processing. The length of the charge is determined by the weight of material needed. Superalloys are very dense, often having a density of about 0.3 pounds per cubic inch.

It is known to form a charge from an ingot by using an abrasive blade or saw to cut the charge off of the ingot. In a variation of this process, an abrasive blade notches one side of the ingot at a desired charge length, and then a press is applied to the ingot to break it at the notch. However, the use of abrasive blades has proven undesirable for two reasons. First, a blade creates a kerf in the ingot equal to the thickness of the blade, and the material from the kerf is lost. Ingots of superalloy material are very costly and the cumulative cost of material lost to kerfs is high. Second, contaminants from the abrasive blade while cutting or notching can become lodged in the charge, especially if the charge is formed from the end of the ingot with a pipe. These contaminants may adversely affect the quality of the charge, and consequently, the quality of the final parts formed from the charge. Another problem arising from notching one side of the ingot is that the resulting break follows an indeterminate path through the ingot. Consequently the size of the charge may be more or less than desired for subsequent processing. If more, then material may have to be removed, resulting in further waste. If less, then a supplementary charge must be created, resulting in more processing time, if not more waste.

Another known process for forming a charge from an ingot involves breaking the ingot over an anvil where the ingot is positioned to contact a sharp point on the anvil at a desired charge length. The sharp point serves as a fulcrum over which the ingot is broken by a press. Yet another process for forming a charge from an ingot involves using a chevron to notch the ingot at the desired charge length and then impacting an end of the ingot to break off the charge at the notch. Both of these processes have the problem of an indeterminate break path on the charge, resulting in a charge having more or less material than needed for the desired part. If there is too much material, the excess material is typically removed from the break edge using a grinding operation, resulting in lost material and increased risk of contamination.

An efficient apparatus and process is needed for forming a charge that maximizes the amount of usable material per ingot and reduces the likelihood of contamination of the material.

### SUMMARY OF THE INVENTION

An apparatus for scoring and breaking ingots into charges is provided. According to the invention, the apparatus comprises a scoring station and a breaking station. The scoring station has a scoring assembly to make a circumferential scoring groove in the ingot at a desired charge length. The breaking station has a hydraulic press to break the ingot at the scoring groove to form the charge. The apparatus can further include a control system to automatically control the apparatus. The ingot is positioned in the press between upper and lower reaction plates where the scoring groove is partially or fully over the lower reaction plate.

According to another aspect of the invention, a process for scoring and breaking ingots into charges is provided. The ingot is weighed at at least two points along the length of the ingot. The density of the ingot is calculated and used to determine a desired charge length needed for a given weight of material. A circumferential scoring is then made in the ingot at a desired charge length. Finally, the charge is broken from the ingot at the scoring.

### BRIEF DESCRIPTION OF THE DRAWINGS

In the drawings:

FIG. 1 is a perspective view of an apparatus according to the present invention.

FIG. 2 is a top view of a scoring station of the apparatus from FIG. 1.

FIG. 3a is a top view of a first embodiment of a cutting tool insert for use with the scoring station from FIG. 2.

FIG. 3b is a side view of the cutting tool insert shown in FIG. 3a.

FIG. 3c is a side view of an ingot with a scoring groove formed by the tool of FIGS. 3a and 3b.

FIG. 4a is a top view of a second embodiment of a cutting tool insert for use with the scoring station from FIG. 2.

FIG. 4b is a side view of the cutting tool insert shown in FIG. 4a.

FIG. 4c is a side view of an ingot with a scoring groove formed by the tool of FIGS. 4a and 4b.

FIG. 5 is a front view of a breaking station of the apparatus from FIG. 1.

FIG. 6 is a cross section of a portion of a breaking station of the apparatus of FIG. 1 showing the positioning of an ingot for breaking.

FIG. 7 is an end view taken along line 7-7 of FIG. 6.

FIG. 8 is a cross section of the portion of FIG. 6 with additional components.

FIG. 9 is an end view taken along line 9-9 of FIG. 8.

FIG. 10 is the view of FIG. 8 immediately after the charge is broken from the ingot.

FIG. 11 is a side view of a charge before finishing.

FIG. 12 is a cross section of a portion of a breaking station of the apparatus of FIG. 1 showing an alternate positioning of an ingot for breaking.

FIG. 13 is a cross section of the portion of FIG. 12 with additional components.

FIG. 14 is the view of FIG. 13 immediately after the charge is broken from the ingot.

FIG. 15 is a cross section of a portion of a breaking station of the apparatus of FIG. 1 showing an alternate ram structure.

### DETAILED DESCRIPTION

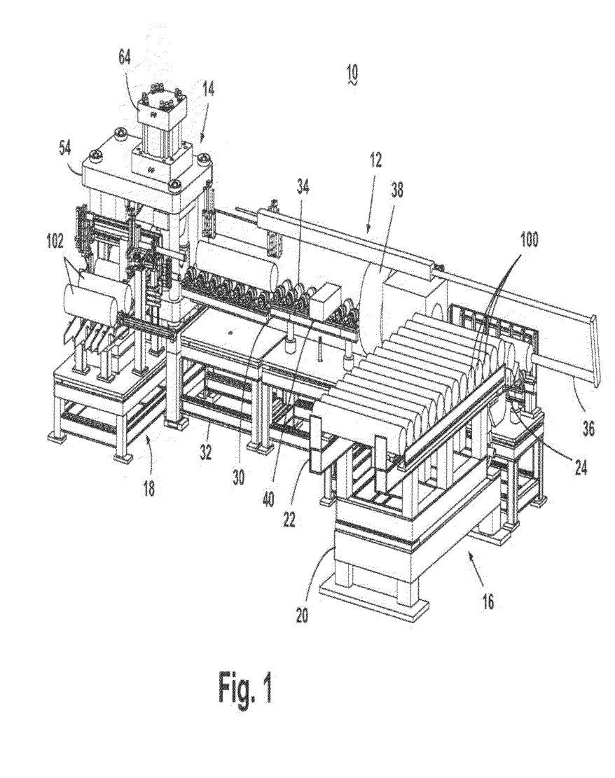

FIG. 1 illustrates an apparatus 10 for scoring and breaking ingots 100 into charges 102 according to the present invention. The apparatus 10 comprises a scoring station 12 and a breaking station 14, preferably operating together synchronously with an appropriate computerized control system (not shown). The apparatus 10 can also comprise a loading station 16 for supplying ingots 100 to the scoring station 12 and a transfer station 18 for transporting charges exiting the breaking station 14. The transfer station 18 can transport the charges to an optional finishing station (not shown), as will be discussed below.

The loading station 16 comprises a base 20 supporting a rack 22 for retaining a supply of ingots 100 and for feeding the ingots to the scoring station 12. The loading station 16 further comprises a weighing assembly 24. The weighing assembly 24 has a pair of scales positioned to weigh both ends of the ingot. The weight information (preferably in digital form) is sent to the control system to calculate the density of the ingot, and this calculation is used to determine the length of charge needed for a given material weight. The material weight needed per charge can be inputted into the control system. Given the density and the needed weight, the control system can calculate the length of the charge necessary to fulfill the needed weight. While illustrated as being a part of the loading station 16, the weighing assembly 24 can alternately be a part of the scoring station 12 or it can be part of a separate station.

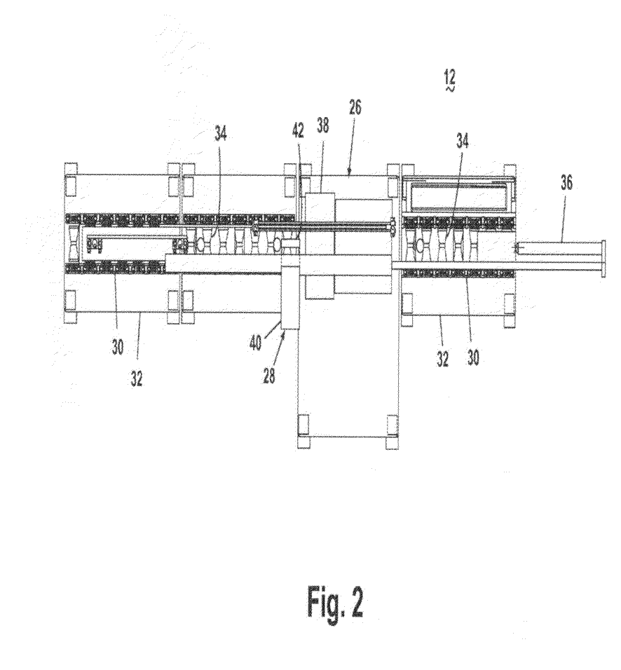

Referring additionally to FIG. 2, the scoring station 12 is primarily a lathe that includes a retaining assembly 26 for securely holding an ingot and a scoring assembly 28 for scoring the ingot. A conveyor 30 transfers an ingot from the weighing station 24 through the retaining assembly 26 and through the scoring assembly 28. The conveyor 30 is supported on a base 32 that may also support the retaining assembly 26 and/or the scoring assembly 28. The conveyor 30 is preferably a linear series of rollers 34 with a movable push arm 36 to advance the ingot over the rollers 34. The conveyor 30 can be vertically movable to accommodate ingots of different diameters. A preferred range of ingot diameters for use with the apparatus 10 is 2″ to any practical upper limit.

The retaining assembly 26 comprises a chuck 38 that is movable between an open position where an ingot 100 can move unimpeded through the scoring station 12 and a closed position where the ingot is clamped within the chuck 38. The chuck 38 is fully rotatable through 360° of movement and powered to cause an ingot clamped therein to rotate. The scoring assembly 28 comprises a tool holder and driver 40 having a cutting tool 42. The tool holder and driver 40 is movable between a disengaged position where the cutting tool 42 is not in contact with the ingot, and an engaged position where the cutting tool 42 contacts a surface of the ingot. When the tool holder and driver 40 is moved to the engaged position as the ingot 100 rotates with the chuck 38, the cutting tool 42 scores the ingot with a groove 102 to a predetermined groove depth. The groove depth is optimized to reduce the material lost from the ingot when cutting the groove. A preferred range of groove depth is 0.06″ to 0.500″, regardless of the diameter of the ingot. The groove depth can be preprogrammed into the control system of the apparatus 10. As the chuck 38 rotates, the material removed from the ingot is hot and oxidizes, rendering it unfit for immediate recycling. If the cutting area is rendered devoid of oxygen, as, for example, if it were flooded with an inert gas to displace oxygen in the work space, the removed material will come off in the form of uncontaminated chips that can be collected and readily recycled for later use.

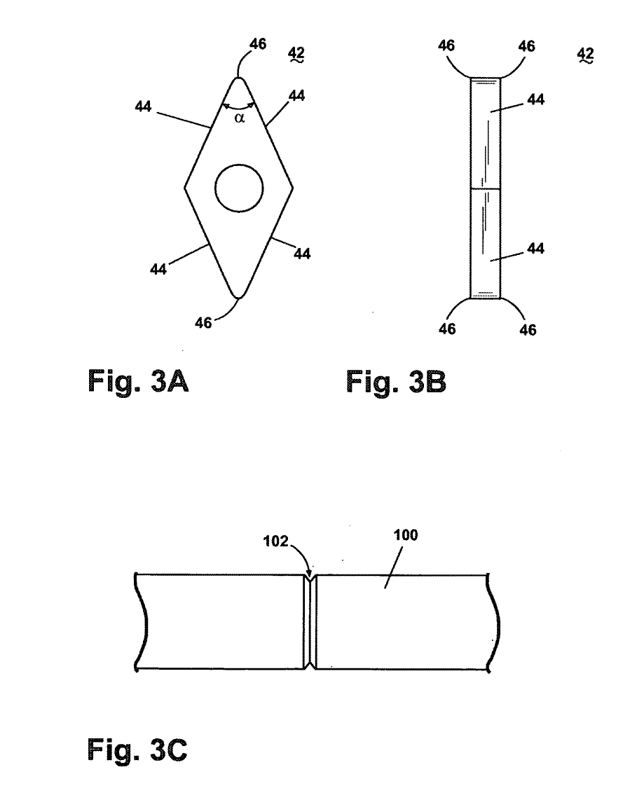

A suitable cutting tool 42 for use with the tool holder and driver 40 is shown in FIGS. 3A and 3B. The cutting tool 42 is preferably diamond-shaped with four straight sides 44 and four cutting vertices 46 to score the ingot. An angle α is preferably 55° to result in a groove of the same angle, although it is within the scope of the invention to use other cutting angles. The cutting angle α preferably ranges from 35-90°. An exemplary cutting tool 42 is commercially available from Greenleaf Corp. (Saegertown, Pa.) and is made of a silicon carbide, fiber-reinforced ceramic material. A scored groove 102 made by the cutting tool 42 can be seen in FIG. 3C.

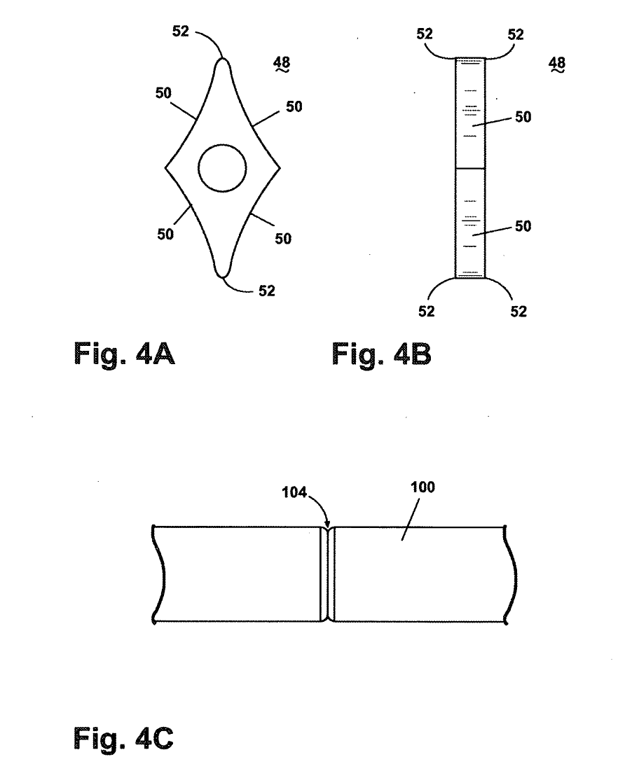

Another suitable cutting tool 48 is shown in FIGS. 4A and 4B and is diamond-shaped with four concave sides 50 and four cutting vertices 52. The concave shape of the sides 50 creates a curved or chamfered groove in the ingot. A scored groove 104 made by the cutting tool 48 can be seen in FIG. 4C. Upon breaking an ingot scored with the cutting tool 48, the resulting charge has a break end having a filleted edge, which is desirable for certain processes used to melt the subsequently formed charge. It has been determined that each edge 46, 52 of the cutting tool 42, 48 can make approximately 10-12 cuts before dulling, so that each cutting tool can be used to make a maximum of 40-48 scores. The speed of chuck rotation and the motion of the tool holder and driver 40 are such that a complete score of an ingot can be completed in a short period of time.

The control system will normally advance the ingot 100 to the correct position beneath the tool holder and driver 40 to make a scoring groove 102, 104 at the desired charge length. A position detector (not shown) can also be provided on the scoring station 12 and in communication with the control system to sense when the ingot 100 is properly positioned. When the ingot 100 is in the correct position beneath the tool holder and driver 40, the chuck 38 will move to the closed position and the scoring assembly 28 will move to the engaged position to make the scoring groove 102, 104. After the scoring groove is made, the ingot will be advanced to the correct position beneath the tool holder and driver 40 for making the next scoring groove at the desired charge length, of another charge is to be made. This cycle continues until the entire ingot has been scored for multiple charges.

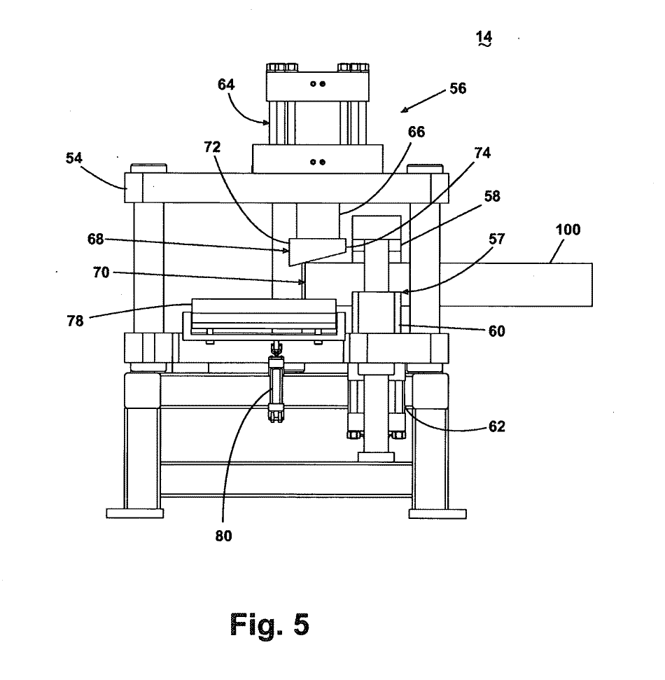

After the scoring operation is complete, the ingot 100 is advanced to the breaking station 14. Referring now to FIG. 5, the breaking station 14 comprises a framework 54 that supports a hydraulic press 56 for breaking the ingot 100 into charges and a support assembly 57 for holding the ingot while the charge is broken off. The support assembly 57 comprises upper and lower reaction plates 58, 60 that are movable relative to one another from an open position where the ingot 100 can move unimpeded through the support assembly, to a closed position where the ingot is held between the upper and lower reaction plates 58, 60. The upper and lower reaction plates 58, 60 are moved by a hydraulic assembly 62 supported on the framework 54. The upper and lower reaction plates 58, 60 are controlled by the control system, and the ingot 100 is advanced by the control system to the correct position beneath the hydraulic press 56 for breaking the charge from the ingot, as discussed below, inasmuch as the control system has already calculated the necessary length of the charge to be formed. As well, the control system can be in communication with a scoring detector (not shown) on the framework 54 that will determine when the scored groove 102, 104 reaches the correct position. The scoring detector can be a sensor that detects when the scored groove 102, 104 in the ingot 100 passes a laser beam.

The hydraulic press 56 comprises a hydraulic assembly 64 operating a ram 66 for vertical movement. Preferably, the ram 66 operates at forces sufficient to fracture the largest diameter ingots. When moved vertically downward, a break pad 68 on the end of the ram 66 is positioned to contact the distal end 70 of the ingot 100 away from the scored groove 102, 104. The distal end 70 of the ingot 100 that is to be broken into a charge (i.e. the unclamped end of the ingot) is positioned over a movable charge support 78. The charge support 78 receives the charge after being broken from the ingot and then is moved by a hydraulic cylinder 80 to discharge the charge from the breaking station 14. The charge can be discharged to the transfer station 18, which can comprise a conveyor similar to the conveyor 30 for the notching station 12 or other suitable means for transporting the charges exiting the breaking station 14.

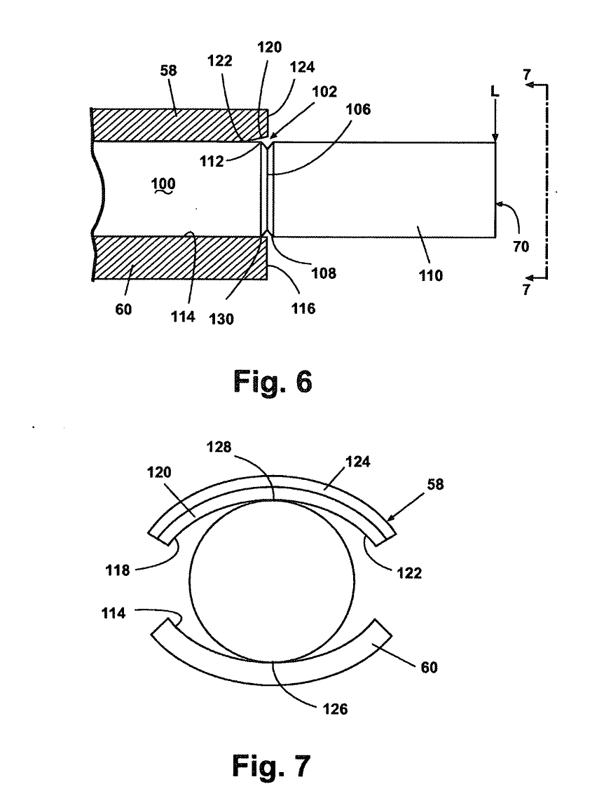

Looking now at FIGS. 6-9, detail about one possible positioning of the ingot during the breaking operation is shown. Here, the ingot 100 has a scored groove 102 comprising a score line 106 at the base of the groove, an anterior shoulder 108 on a charge portion 110 of the ingot (i.e., that portion of the ingot that will become the charge) and a posterior shoulder 112 on the other side of the score line from the anterior shoulder. The lower reaction plate 60 is curved on a radius larger than the radius of the ingot 100 (see FIG. 7). It has an upper face 114 that terminates at a forward edge 116. The upper reaction plate 58 is also curved on a radius larger than the radius of the ingot 100. It has a contact surface 118 and a relief section 120 chamfered from a forward corner 122 of the contact surface to a forward edge 124 of the upper reaction plate. When properly placed, the ingot 100 is positioned between the upper and lower reaction plates 58, 60 within the concave curvatures of the plates and held securely between them so that the contact points 126, 128 between the reaction plates 58, 60 and the ingot 100 are directly opposite each other. The curvatures of the reaction plates 58, 60 help to assure the opposite location of the contact points 126, 128. As well, the larger radius of the reaction plates 58, 60 will facilitate an ingot 100 of any radius, provided it is less than the radius of the reaction plates. One or both reaction plates can be curved. As well, it is possible for neither to be curved, so long as one can accurately position them so that the contact points 126, 128 are opposite each other.

Looking again at FIG. 6, the ingot 100 in this embodiment is positioned such that the forward edge 116 of the lower reaction plate 60 is located between the anterior and posterior shoulders 108, 112 of the scored groove 102. The upper surface 114 of the lower reaction plate bears 60 against the ingot 100 at the lower contact point 126. It will be apparent that the posterior shoulder 112 is positioned on the upper surface 114 at what will become a loading point 130. The upper reaction plate 58 will be positioned so that the relief section 120 will extend over the posterior shoulder 112, with the forward corner 122 of the contact surface 118 disposed behind the loading point 130, i.e., further away from the posterior shoulder 112 than the loading point 130. The ram break pad 68 will be positioned to apply a load L to the distal end 70 of the ingot 100. The loading point 130 becomes the fulcrum about which the loading force L generates the moment. As the load L is applied, reaction forces at the relief section 120 further reduce strain at the posterior shoulder 112 of the scoring groove 102. It has been found that this positioning appears to be preferable for ingots 100 with less ductility.

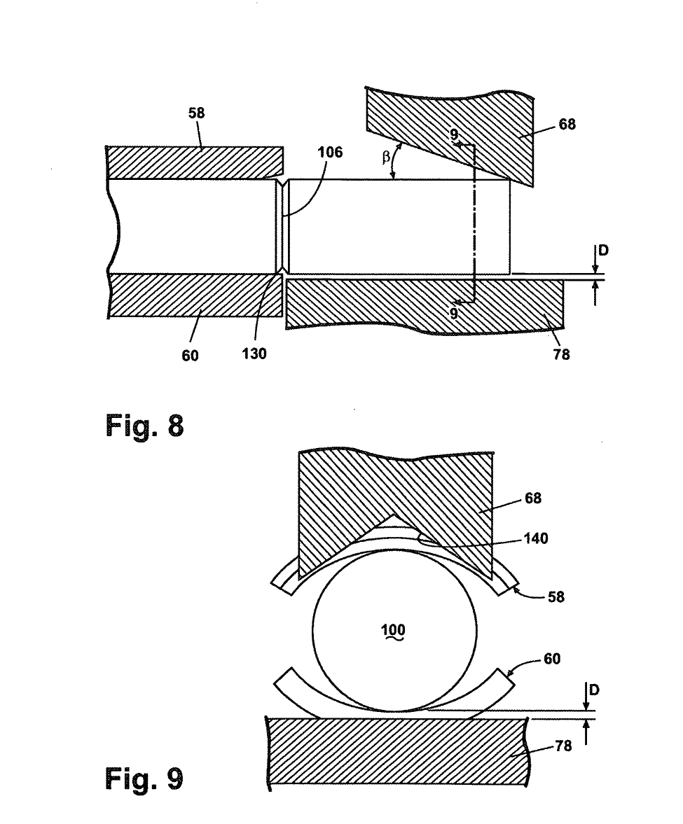

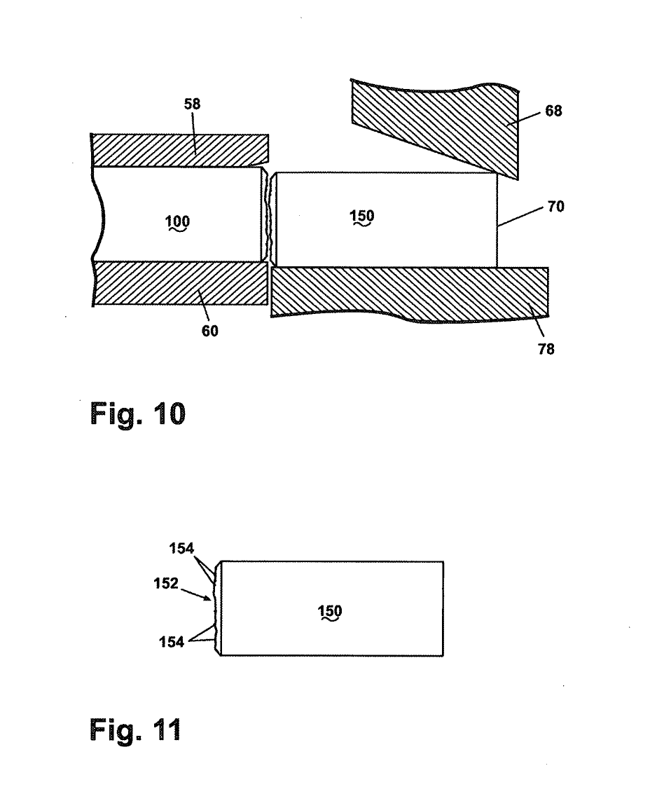

Looking now more closely at FIGS. 8 and 9, it will be seen that the break pad 68 has a wide angle grooved face 140 set at an angle relative to the ingot 100. The wide angled grooved face 140 is dimensioned to contact an upper portion of the ingot 100, regardless of the diameter of the ingot. The angle β is selected to enable the break pad 68 to contact the ingot 100 only at the distal end 70. The charge support 78 is positioned beneath the ingot 100, spaced slightly away therefrom at a distance D that depends on the type of material forming the ingot. The distance D will be greater for a more ductile material and smaller for a less ductile material. Looking now also at FIG. 10, continued downward movement of the ram break pad 68 against the distal end 70 of the ingot 100 increases the load L, causing a rapidly increasing moment about the loading point 130. When the moment exceeds the strength of the ingot 100, a stress fracture is caused to propagate more or less along the score line 106, separating a charge 150 from the reminder of the ingot 100 at a break face 152. The charge falls by gravity to the charge support 78 for further processing.

When the break occurs, a huge shock is transmitted to the lower reaction plate 60 from the loading point 130 due to the large reaction load. Consequently, the reaction plates 58, 60, and especially the lower reaction plate 60, are preferably made of compressively resistant, shock resistant tough material that is not brittle. An exemplary material is S-7 steel with at least 54-56 Rockwell C hardness.

Often, the break face 152 of the charge 150 will be rough with sharp points 154. A potential problem with sharp points 154 on the break face 152 is that when the charge is later dropped into a crucible, the sharp points can interact with the surface of the crucible and contaminate the charge, compromising the purity of the finished product. Consequently, a finishing operation can be optionally performed after the charge 150 exits the breaking station 14 to remove the sharp points from the break face 152. The transfer station 18 can transport the charge 150 to a finishing station. The finishing station can comprise an apparatus for any desired finishing process that will remove or otherwise dull any sharp points from the break face 152 on the charge. One suitable finishing process is needle peening from a needle gun, where a cluster of steel or stainless steel needles repeatedly impacts the break face 152 of the charge 150 to blunt any sharp points. Suitable finishing processes will preferably avoid the possibility of contamination of the break face.

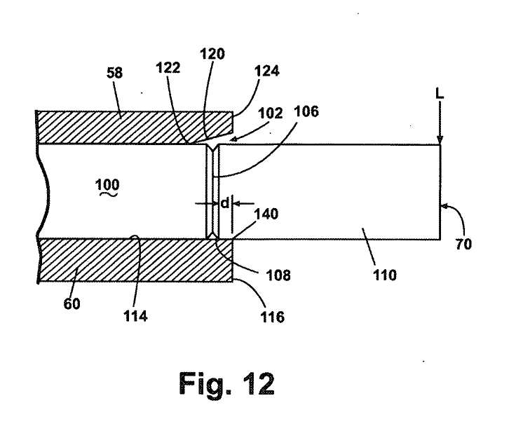

Looking now at FIGS. 12-14, one can see another embodiment of positioning the ingot 100 for breaking in accordance with the invention. It has been found that this embodiment appears to be preferred for ingots with greater ductility. Like components bear like numbers from the embodiment shown in FIGS. 6-11. Here, the ingot 100 in this embodiment is positioned such that the forward edge 116 of the lower reaction plate 60 is located past both the anterior and posterior shoulders 108, 112 of the scored groove 102. In other words, the scored groove 102 is positioned completely over the lower reaction plate 60. The upper surface 114 of the lower reaction plate bears 60 against the ingot 100 at the lower contact point 126. It will be apparent that the forward edge 116 of the lower reaction plate 60 is positioned adjacent the charge portion 110 at what will become a loading point 140. A typical distance d between the loading point 140 and the anterior shoulder 108 will be about ⅞″, although an acceptable range can be anywhere from just over zero to about an inch. The upper reaction plate 58 will be positioned so that the relief section 120 will extend over the posterior shoulder 112, with the forward corner 122 of the contact surface 118 disposed behind the loading point 140, preferably on the other side of the scoring groove 102. As the load L is applied, reaction forces at the relief section 120 further reduce strain at the loading point 140. The ram break pad 68 will be positioned to apply a load L to the distal end 70 of the ingot 100.

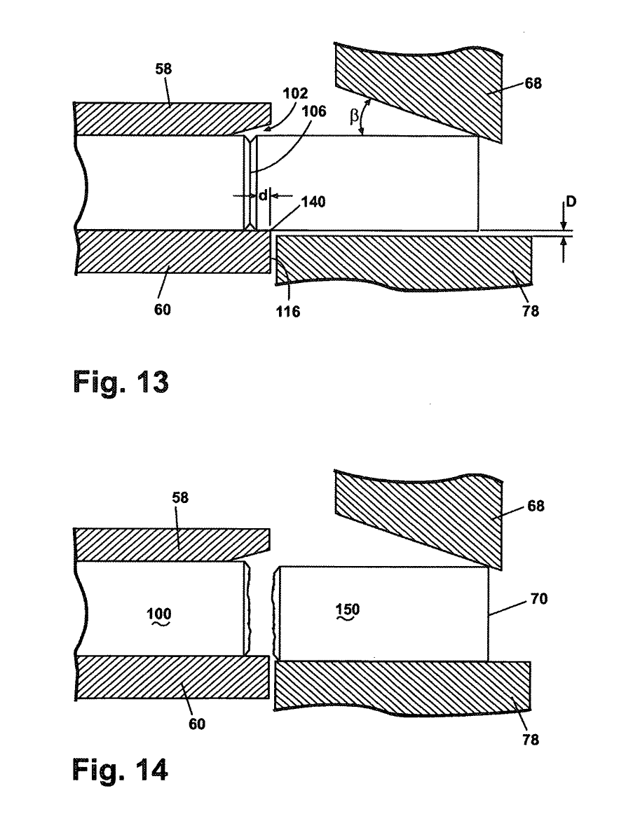

The loading point 140 becomes the fulcrum about which the load L generates the moment. FIG. 13 shows the ram break pad 68 generating the load L and the positioning of the charge support 78 and FIG. 14 shows the position of the various components after breaking. It has been found that this positioning appears to be preferable for ingots 100 with higher ductility.

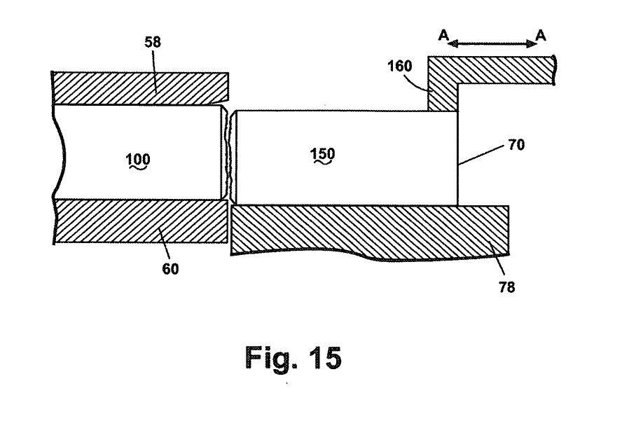

The ductility of the material forming the ingots 100 will also determine where on the charge portion 110 the loading force L is to be applied. Lower ductility suggests that the loading force L will be applied as heretofore shown, i.e., at the distal end 70 of the ingot 100. But a higher ductile material may require the loading force L to be applied inward of the distal end 70. FIG. 15 shows an embodiment that will enable adjustable positioning of the loading force L. A movable ram break pad 160 is disposed in the hydraulic press 56 to be moved laterally, parallel to the longitudinal axis of the ingots 100, i.e., along the line A-A. In this manner, the control system can position the ram break pad 160 anywhere for contact on the upper surface of the charge portion.

It can be seen that a process for scoring ingots and breaking them into individual charges according to the invention includes scoring the circumference of an ingot with a shallow groove and then breaking the ingot at the score line. This process can be accomplished with the apparatus 10. One or more ingots 100 are placed on the rack 22. The forwardmost ingot is advanced to the weighing station 24. The proper charge length for a desired weight of material is calculated by the control system from the information provided by the weighing station 24. Since the weighing station 24 has scales positioned at more than one point along the length of the ingot, the density of material at different points can be taken into account. Thus a single ingot 100 may be divided into charges of unequal lengths, but each having the same weight. The ingot 100 is then transferred to the conveyor 30, which advances the ingot to the scoring station 12. When the ingot 100 is correctly positioned within the scoring assembly 28 to make a score for the first charge, the chuck 38 will move to the closed position. The scoring assembly 28 then moves to the engaged position where the cutting tool 42 contacts the surface of the ingot to make an initial scoring groove 102 at a predetermined groove depth. The chuck 38 is then rotated 360° to extend the scoring groove circumferentially around the ingot. The cutting tool 42 is then moved away from the ingot to the disengaged position and the chuck 38 is opened. The ingot 100 is then advanced a length equal to the desired charge length, whereupon the chuck 38 closes and a second scoring groove 102 is made. This continues until the entire ingot 100 has been scored to define the charges to be broken off from the ingot. The ingot 100 is then advanced by the conveyor 30 to the breaking assembly 14. The detector determines when the ingot score line 106 reaches the correct position beneath the hydraulic press 56 for breaking the first charge from the ingot. When the ingot 100 is in the correct position with respect to the hydraulic press 56, the clamps 58, 60 are moved to the closed position. The hydraulic press 56 is then actuated whereby the ram break pad 68 bears against the distal end 70 of the ingot 100 to break off a charge 150. The charge 150 is received by the charge support 78, which moves to discharge the charge from the breaking station 14. The ingot 100 is released by the clamps 58, 60 and advanced such that the next score line 106 is correctly positioned beneath the hydraulic press 56. The cycle continues until the entire ingot 100 has been broken into charges 150. After exiting the breaking assembly 14, the charges 150 can optionally be transferred to a finishing station to smooth any sharp points on the break faces 152 of the charges 150.

The process and apparatus according to the invention offers several advantages over prior art processes and apparatuses. First, material lost during the creation of charges from an ingot is minimized. The groove depth can be optimized to minimize the amount of material cut from the ingot when the scoring groove is cut. Further, since a lathe is used to score the ingot, the material that is cut from the ingot comes off in chips that can be collected and recycled for later use. As well, the risk of contamination of the charge is reduced. By using a cutting tool made of a hard material, such as a silicon carbide, fiber-reinforced ceramic, to make a shallow groove, few particles from the cutting tool will be transferred to the ingot. Further, the apparatus is extremely efficient. The apparatus is fully automated and thus will save time and operating cost. The apparatus is adjustable to accommodate ingots of different diameters

While the invention has been specifically described in connection with certain specific embodiments thereof, it is to be understood that this is by way of illustration and not of limitation, and the scope of the appended claims should be construed as broadly as the prior art will permit. For example, the ram break pad 68 need not be grooved or angled, but can be positioned to contact anywhere on the charge portion 110. But it will be apparent that the further away from the scored groove (120, 104) the ram break pad contacts the charge portion 110, the greater the moment about the loading point 130.

1. A method of forming a charge 4504 from an ingot 0404 o superalloy material comprising:
scoring the circumference of the ingot with a groove,
holding the ingot between upper and lower reaction plates adjacent the groove, and
pressing against a charge portion of the ingot away from the groove until a stress fracture in the groove causes the charge to break away from the ingot at the groove.

2. The method of claim 1 wherein the groove is defined by a scoring line between an anterior shoulder and a posterior shoulder, and the lower reaction plate has a forward edge, the forward edge being positioned between the anterior and posterior shoulders to define a loading point in the holding step.

3. The method of claim 1 wherein the groove is defined by a scoring line between an anterior shoulder and a posterior shoulder, and the lower reaction plate has a forward edge, the forward edge being positioned adjacent the lower reaction plate to define a loading point in the holding step.

4. The method of claim 1 wherein the upper reaction plate has a relief section extending between a forward corner and a forward edge, the forward corner being positioned away from the groove.

5. The method of claim 1 further comprising finishing a break face on the charge to reduce sharp points on the break face.

6. The method of claim 5 wherein the finishing step comprises needle peening the break face.

7. The method of claim 1 wherein the charge portion of the ingot is pressed at a distal end during the pressing step.

8. The method of claim 1 further comprising determining the length of the charge portion.

9. The method of claim 8 wherein the determining step comprises inputting a predetermined weight of the desired charge, weighing the ingot at more than one point to ascertain its density over its length, and calculating the length of the charge portion necessary to result in a charge of the predetermined weight.

10. An apparatus for forming a charge from a cylindrical ingot of superalloy material, comprising a scoring station for making a circumferential scored groove in the ingot and a breaking station for causing a charge portion of the ingot to break at the scored groove to form the charge.

11. The apparatus of claim 10 further comprising a weighing assembly to calculate the length of the charge portion.

12. The apparatus of claim 10 wherein the scoring station is a lathe.

13. The apparatus of claim 10 further comprising a cutting tool capable of forming a scored groove with an angle between 35 and 90 degrees.

14. The apparatus of claim 10 wherein the breaking station comprises a support assembly including upper and lower reaction plates that are movable relative to one another from an open position where the ingot can move unimpeded through the support assembly, to a closed position where the ingot is held between the upper and lower reaction plates.

15. The apparatus of claim 14 wherein the upper reaction plate has a relief section extending between a forward corner and a forward edge, whereby the forward corner is positioned away from the groove in the closed position.

16. The apparatus of claim 14 wherein the groove is defined by a scoring line between an anterior shoulder and a posterior shoulder, and the lower reaction plate has a forward edge, the forward edge being located between the anterior and posterior shoulders to define loading point in the closed position.

17. The apparatus of claim 14 wherein the groove is defined by a scoring line between an anterior shoulder and a posterior shoulder, and the lower reaction plate has a forward edge, the anterior shoulder being located adjacent the lower reaction plate to define a loading point in the closed position.

18. The apparatus of claim 14 wherein at least one of the upper and lower reaction plates is curved.

19. The apparatus of claim 18 where the radius of curvature is larger than the radius of the ingot.

20. The apparatus of claim 10 wherein the breaking station comprises a ram break pad for pressing against the charge portion.

21. The apparatus of claim 20 wherein the ram break pad has a wide angled groove face set an angle relative to the ingot so as to contact the distal end of the ingot.
